(19) United States
(12) Patent Application Publication
(10) Pub. No.: US 2013/0059104 A1
(43) Pub. Date: Mar. 7, 2013

(54) FRENCH NAIL STICKER AND MANUFACTURING METHOD THEREOF

(71) Applicant: Sung Yong Chang, Roslyn Heights, NY (US)

(72) Inventor: Sung Yong Chang, Roslyn Heights, NY (US)

(21) Appl. No.: 13/314,229

(22) Filed: Dec. 8, 2011

(30) Foreign Application Priority Data
Sep. 2, 2011 (KR) 10-2011-0088944
Oct. 13, 2011 (KR) 10-2011-0104591

(51) Int. Cl. A45D 29/00; A45D 31/00; B32B 38/10

(52) U.S. Cl. 428/41.8; 156/267

(57) ABSTRACT

Provided is a French nail sticker formed into the shape of the yellow line of a nail including: a sticker main body having a convex free end and a concave hyponychium end opposite to the free end; a release liner disposed on the bottom surface of the sticker main body and intended to be bound detachably with the sticker main body; and a guide portion intended to be bound detachably with the top surface of the sticker main body and including a grip portion protruding toward the free end of the sticker main body. It is not required to scrape out the sticker main body manually when the sticker main body is detached from the release liner. Therefore, it is possible to prevent the sticker main body from being damaged by the detachment of the sticker main body from the release liner.

### CROSS-REFERENCE TO RELATED APPLICATIONS

This application claims priority under 35 U.S.C. §119 to Korean Patent Applications Nos. 10-2011-0088944 and 10-2011-0104591, filed on Sep. 2, 2011 and Oct. 13, 2011, respectively, in the Korean Intellectual Property Office, the disclosure of which is incorporated herein by reference in its entirety.

### TECHNICAL FIELD

The following disclosure relates to a French nail sticker, and more particularly to a French nail sticker capable of being attached to/detached from a release liner without any damages on the sticker main body and applied with ease to nails.

### BACKGROUND

In general, when users intend to improve the shapes of their nails, they apply manicure on their nails to perform nail art with a desired pattern. However, nail art including applying manicure to nails requires a complicated and delicate procedure and is inconvenient due to the time needed for drying the applied solution. Particularly, in the case of nail art, such as French nail art, including coloring the end portion of a nail, it is required that each nail has a uniform area to which manicure is applied, and a smile line, which is a terminal line of French nail art positioned at the side of a nail bed, is applied in a uniform and constant manner. However, it is difficult for non-skilled persons to carry out such nail art work by themselves. Moreover, even when the user is a skilled person, carrying out French nail art manually and directly on her/his nails is problematic in that the shapes applied to both hands by French nail art are not uniform depending on whether the user is right-handed or left-handed.

To overcome the above-mentioned problems, the users have asked a technical specialist of nail art, working in a nail shop or the like, to improve the shapes of their nails. However, when the users ask a technical specialist to perform French nail art, they pay for the nail art work every time they need the service and thus they have burdened themselves with high cost.

Therefore, there has been a need for developing a French nail sticker so that even non-skilled persons may form a uniform smile line of French nail art and perform French nail art with a uniform shape by themselves.

### SUMMARY

An embodiment of the present invention is directed to providing a French nail sticker capable of being attached to/detached from a release liner without any damages on the sticker main body and applied to nails with ease.

Another embodiment of the present invention is directed to providing a method for manufacturing a French nail sticker that may be applied easily to nails even by non-skilled persons.

In one general aspect, there is provided a French nail sticker formed into the shape of the yellow line of a nail, and including:

a sticker main body having a convex free end and a concave hyponychium end opposite to the free end;

a release liner disposed on the bottom surface of the sticker main body and intended to be bound detachably with the sticker main body; and

a guide portion intended to be bound detachably with the top surface of the sticker main body and including a grip portion protruding toward the free end of the sticker main body.

According to an embodiment, the sticker main body may include:

a first adhesive layer capable of being attached to/detached from the release liner; and

a base layer disposed on the top of the first adhesive layer and bound firmly to the first adhesive layer.

The sticker main body may further include a design layer colored and formed with a pattern on the top of the base layer, and a top coat layer provided on the uppermost part of the sticker main body in contact with the guide portion.

The base layer may be made of at least one selected from polypropylene (PP), polyethylene (PE), polyvinyl chloride (PVC), polyvinylidene chloride (PVDC), ethylene vinyl acetate (EVA), polyethylene terephthalate glycol (PETG) and polyurethane (PU).

The guide portion may include a guide film and a second adhesive layer, wherein the guide film includes an adhesive region disposed on the top of the sticker main body, and a grip portion extending from the adhesive region and protruding out of the free end of the sticker main body; and the second adhesive layer is adhered detachably to the top of the sticker main body on one surface thereof, and adhered and fixed to the bottom of the adhesive region on the other surface thereof.

The guide film may include:

a primer layer bound with the second adhesive layer and removed from the release liner;

a marking layer printed on the top of the primer layer and representing the center of the sticker main body; and

a protective layer stacked on the top of the marking layer.

The adhesion between the second adhesive layer and the sticker main body may be higher than the adhesion between the first adhesive layer and the release liner.

After carrying out a Pull-Off Test according to ASTM D4541, the adhesion between the second adhesive layer and the sticker main body may be 1.5-4 times higher than the adhesion between the first adhesive layer and the release liner.

The top coat layer of the sticker main body may include a UV coating agent, and the primer layer may include an acrylate-based resin.

The marking layer may further include a size mark representing the size of the sticker main body.

The adhesive region may be formed with the same shape as the sticker main body.

In another general aspect, there is provided a method for manufacturing a French nail sticker, including:

stacking an adhesive and a base film to be bound with the adhesive on the top of a release liner;

printing the shape of the sticker main body on the top of the base film;

half-blade cutting the base film and the adhesive along the shape of the sticker main body printed on the top of the base film;

removing the base film passed through the half-blade cutting from the release liner and forming the sticker main body on the top of the release liner; and

forming a guide portion on the top surface of the sticker main body formed on the top of the release liner.

According to an embodiment, the operation of forming the guide portion may include:

applying a guide adhesive on the top of the sticker main body;

stacking a primer layer on the top of the guide adhesive;

forming a marking layer including a center line representing the center of the sticker main body on the top surface of the primer layer; and

forming a protective layer stacked on the top of the marking layer so that the content provided by the marking layer is maintained even under the application of external force,

wherein the primer layer may be formed in such a manner that it protrudes out of the free end of the sticker main body.

The base film may be made of at least one selected from PP, PE, PVC, PVDC, EVA, PETG and PU.

Other features and aspects will be apparent from the following detailed description and the claims.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a planar view of the French nail sticker according to an embodiment.

FIG. 2 is a sectional view of the French nail sticker according to an embodiment.

FIG. 3 is a block diagram illustrating the method for manufacturing a French nail sticker according to an embodiment.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

In general, French nail art is performed at the site of a free edge of nail and is realized in a shape similar to the yellow line of a nail. The yellow line means a nail between the free edge of nail and the hyponychium and is not in contact with the skin. When carrying out nail art not over the whole nail plate but on a portion of nail, like French nail art, it is difficult to define the boundary of a desired pattern.

The French nail sticker disclosed herein is provided to solve the above-mentioned problem. Particularly, the French nail sticker disclosed herein allows even non-skilled persons to form a delicate pattern on their nails by themselves when the pattern is required to be formed on a portion of nail. In other words, the French nail sticker disclosed herein allows users to carry out French nail art with ease.

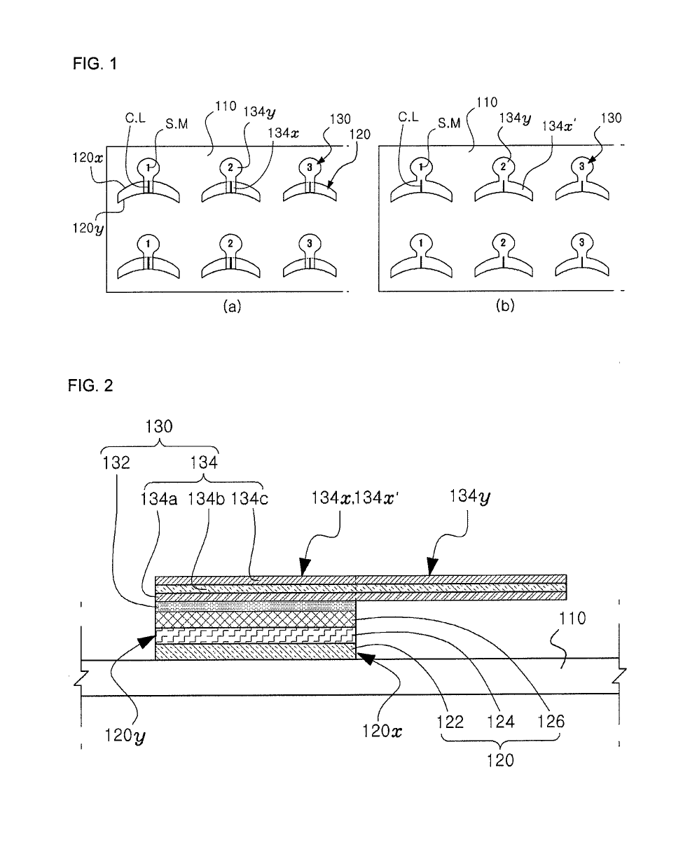

FIG. 1 is a planar view of the French nail sticker according to an embodiment, and FIG. 2 is a sectional view of the French nail sticker according to an embodiment.

The French nail sticker disclosed herein is broadly divided into a sticker main body 120 applied to a nail, a release liner 110 protecting the shape of the sticker main body 120, and a guide portion 130. Particularly, as shown in portion (a) of FIG. 1, the French nail sticker disclosed herein is formed into the shape of the yellow line of a nail, and includes:

a sticker main body 120 having a convex free end 120x and a concave hyponychium end 120y opposite to the free end;

a release liner 110 disposed on the bottom surface of the sticker main body 120 and intended to be bound detachably with the sticker main body 120; and

a guide portion 130 intended to be bound detachably with the top surface of the sticker main body 120 and including a grip portion 134y protruding toward the free end 120x of the sticker main body 120.

The free end 120x of the sticker main body 120 has a convex shape and is disposed at the free edge that is the terminal end of a nail when applied to the nail. In addition, the hyponychium portion 120y generally corresponds to a smile line formed while carrying out French nail art, and has a curvature in the same direction as the free end 120x.

The sticker main body 120 is applied actually to a nail and includes an adhesive component coated on the bottom surface thereof. Therefore, the release liner 110 provided on the bottom surface of the sticker main body 120 serves to prevent contaminants, such as dust, from being attached to the adhesive component formed on the sticker main body 120 before applying the sticker main body 120 to a nail. Since the release liner 110 has release property, the adhesive component of the sticker main body 120 does not remain on the release liner 110 but is detached easily therefrom.

The guide portion 130 is attached to the top of the sticker main body 120. Similarly to the sticker main body 120 detachable from the release liner 110, the guide portion 130 is detachable from the sticker main body 120. The guide portion 130 facilitates detaching the sticker main body 120 from the release liner 110 and attaching the sticker main body 120 to a nail.

The guide portion 130 includes a guide film 134 and a second adhesive layer 132, wherein the guide film 134 includes an adhesive region 134x disposed on the top of the sticker main body 120, and a grip portion 134y extending from the adhesive region 134x and protruding out of the free end 120x of the sticker main body 120; and the second adhesive layer 132 is adhered detachably to the top of the sticker main body 120 on one surface thereof, and adhered and fixed to the bottom of the adhesive region 134x on the other surface thereof.

The guide portion 130 is divided into the guide film 134 and the second adhesive layer 132, and the second adhesive layer 132 is not formed totally on the bottom surface of the guide film 134 but is applied only to the guide film 134 at the position to be bound with the sticker main body 120. In other words, the guide film 134 may be divided into the adhesive region 134x having the second adhesive layer 132 coated on the bottom surface thereof, and the grip portion 134y having no second adhesive layer 132 applied thereto. The grip portion 134y is held by a hand when it is required to detach the sticker main body 120 from the release liner 110. In other words, when detaching the sticker main body 120 from the release liner 110, it is possible to remove the sticker main body 120 from the release liner 110 with ease without scraping out the sticker main body 120 manually or bending the release liner 110. Therefore, it is possible to prevent the sticker main body 120 from being damaged during the detachment of the sticker main body 120 from the release liner 110. For this, one surface of the second adhesive layer 132 is adhered detachably to the top of the sticker main body 120 and the other surface of the second adhesive layer 132 opposite thereto is adhered and fixed to the bottom of the adhesive region 134x. In this manner, it is possible to maintain the second adhesive layer 132 attached to the guide film 134, when the guide portion 130 is separated from the sticker main body 120.

The adhesive region 134x′ disposed on the top surface of the sticker main body 120 may be formed on a portion of the sticker main body. In a variant, as shown in portion (b) of FIG. 1, the adhesive region 134x′ may be formed in the same shape as the sticker main body 120 so as to prevent removal of the pattern printed on the sticker main body 120 or formation of scratches on the surface of the sticker main body 120.

As shown in FIG. 2, the sticker main body 120 includes: a first adhesive layer 122 capable of being attached to/detached from the release liner 110; and a base layer 124 disposed on the top of the first adhesive layer 122 and bound firmly to the first adhesive layer 122.

Although the sticker main body 120 may be realized to have a design capable of decorating a nail only with colors provided by the base layer 124, the base layer 124 may further include an additional pattern or color to improve the appearance of the sticker main body 120. In other words, the sticker main body 120 may further include an additional design layer 126 on the top of the base layer 124, and a top coat layer 128. In this case, the guide portion 130 is attached to the top coat layer 128 of the sticker main body 120. When the sticker main body 120 has no additional design layer 126, the top coat layer 128 may be disposed on the top of the base layer 124 so that it is positioned always on the uppermost part of the sticker main body 120. In other words, the top coat layer 128 provided on the uppermost part of the sticker main body 120 may serve to protect the surfaces of the base layer 124 or the design layer 126 disposed on the bottom of the top coat layer 128.

In addition, when the sticker main body 120 has the top coat layer 128 on the top surface thereof, it is possible to impart a gloss to the surface of the design layer 126 and to improve the appearance of the sticker main body 120. Furthermore, the material forming the top coat layer 128 may serve to maintain a certain degree of adhesion, while facilitating the separation between the sticker main body 120 and the guide portion 130 after the sticker main body 120 is attached to a nail.

The base layer 124 of the sticker main body 120 may be made of at least one selected from polypropylene (PP), polyethylene (PE), polyvinyl chloride (PVC), polyvinylidene chloride (PVDC), ethylene vinyl acetate (EVA), polyethylene terephthalate glycol (PETG) and polyurethane (PU). In other words, the base layer 124 may be formed of any one material selected from PP, PE, PVC, PVDC, EVA, PETG and PU. In a variant, two or materials may be selected from PP, PE, PVC, PVDC, EVA, PETG and PU and blended at an adequate ratio to form the base layer 124. In addition, particular examples of the adhesives forming the first adhesive layer 122 and the second adhesive layer 132 may include solvent-free adhesives, such as acrylic-, urethane acrylic-, silicone-, epoxy- and rosin-based adhesives, and solvent-based adhesives, such as acrylic-, urethane acrylic-based, silicone-based and epoxy-based adhesives.

As shown in FIG. 2, the guide portion 130 includes the guide film 134 and the second adhesive layer 132. The guide film 134 includes an adhesive region 134x disposed on the top of the sticker main body 120, and a grip portion 134y extending from the adhesive region 134x and protruding out of the free end 120x of the sticker main body 120. The second adhesive layer 132 is adhered detachably to the top of the sticker main body 120 on one surface thereof, and adhered and fixed to the bottom of the adhesive region 134x on the other surface thereof. In other words, the guide film 134 may be divided into the adhesive region 134x having the second adhesive layer 132 on the bottom surface thereof, and the grip portion 134y having no second adhesive layer 132 applied thereto. Therefore, when attaching the sticker main body 120 to a nail, the grip portion 134y having no second adhesive layer 132 is held by a hand to separate the sticker main body 120 from the release liner 110.

When the adhesion between the second adhesive layer 132 and the sticker main body 120 is higher than the adhesion between the first adhesive layer 122 and the release liner 110, merely pulling the grip portion 134y without direct contact with the sticker main body 120 allows the sticker main body 120 to be detached easily from the release liner 110. Therefore, it is possible to prevent deformation of the shape of the sticker main body 120 during the detachment of the sticker main body 120 from the release liner 110.

Particularly, the adhesion between the second adhesive layer 132 and the sticker main body 120 may be 1.5-4 times higher than the adhesion between the first adhesive layer 122 and the release liner 110. To determine the adhesion, a Pull-Off Test according to ASTM D4541 is used. When the adhesion between the second adhesive layer 132 and the sticker main body 120 is below a level of 1.5 times higher than the adhesion between the first adhesive layer 122 and the release liner 110, the sticker main body 120 may not be detached from the release liner 110 but only the guide portion 130 may be separated from the sticker main body 120 depending on the direction in which the grip portion 134y is pulled. In this case, it is required to hold the sticker main body 120 directly by a hand to detach the sticker main body 120 from the release liner 110. Therefore, the first adhesive layer 122 provided on the bottom of the sticker main body 120 becomes in contact with the hand, resulting in a drop in adhesion or deformation of the appearance of the sticker main body 120. When the adhesion between the second adhesive layer 132 and the sticker main body 120 exceeds a level of 4 times higher than the adhesion between the first adhesive layer 122 and the release liner 110, the sticker main body 120 may be detached easily from the release liner 110 but the guide portion 130 may not be separated easily from the sticker main body 120 after applying the sticker main body 120 to a nail. In other words, a portion of the second adhesive layer 132 disposed on the bottom of the adhesive region 134x remains on the sticker main body 120 as a residue during the separation between the guide portion 130 and the sticker main body 120, resulting in degradation of the appearance of the sticker main body 120. Therefore, according to an embodiment, the adhesion between the second adhesive layer 132 and the sticker main body 120 may be 1.5-4 times higher than the adhesion between the first adhesive layer 122 and the release liner 110.

As described above, to facilitate the separation between the second adhesive layer 132 and the sticker main body 12 while maintaining a predetermined degree of adhesion between the second adhesive layer 132 and the sticker main body 120, the French nail sticker may further include a top coat layer 128. The top coat layer may be made of a UV coating agent, and a primer layer 134a to which the second adhesive layer 132 is adhered and fixed may be an acrylate-based resin. In other words, the top coat layer 128 and the primer layer 134a are formed by using materials capable of providing higher adhesion between the second adhesive layer 132 and the primer layer 134a as compared to the adhesion between the second adhesive layer 132 and the top coat layer 128. In this manner, it is possible to prevent the residue of the second adhesive layer 132 from remaining on the top of the top coat layer 128 when the guide portion 130 is detached after applying the sticker main body 120 to a nail. Particular examples of the acrylate-based resin may include, but are not limited to methyl methacrylate, methyl acrylate, ethyl methacrylate, ethyl acrylate, or the like.

In addition, the guide film 134 of the guide portion 130 includes:

a primer layer 134a bound with the second adhesive layer 132 and removed from the release liner 110;

a marking layer 134b printed on the top of the primer layer 134a and representing the center of the sticker main body 120; and

a protective layer 134c stacked on the top of the marking layer 134b.

Particularly, after forming the primer layer 134a on the top of the second adhesive layer applied to the sticker main body, a center line representing the center of the sticker main body 120 may be printed on the top of the primer layer as required, thereby forming the marking layer 134b. To prevent the marking layer 134b from being delaminated by external force, the protective layer 134c may be stacked on the top of the marking layer. The protective layer 134c may be formed of an epoxy resin, etc. In addition, a center line and a size mark may be formed on the guide portion 130. The center line represents the center of the sticker main body 120 and the size mark represents the size of the sticker main body 120. Therefore, it is possible to check whether the sticker main body 120 is suitable for the user's nail or not before separating the thin film of the sticker main body 120 from the release liner 110. In addition, it is possible to align the central portion of the nail with the center line of the sticker main body 120 before applying the sticker main body 120 to the nail. As a result, it is possible to apply the sticker main body 120 to an adequate position of the nail at once while avoiding a need for repeating attachment/detachment of the sticker main body 120 several times. In other words, according to the guide portion 130 provided on the top of the sticker main body 120, it is possible to prevent the sticker main body 120 from being damaged by detachment of the sticker main body 120 from the release liner 110 and attachment of the sticker main body 120 to a nail.

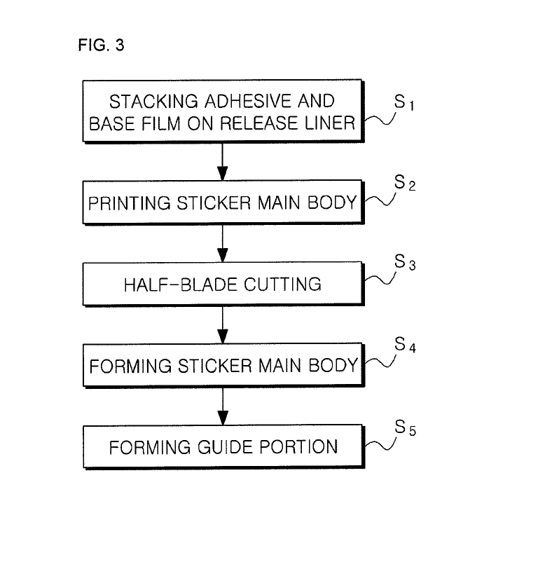

FIG. 3 is a block diagram illustrating the method for manufacturing a French nail sticker according to an embodiment.

The French nail sticker disclosed herein may be obtained by the method described hereinafter. As shown in FIG. 3, there is provided a method for manufacturing the French nail sticker, including:

stacking an adhesive and a base film to be bound with the adhesive on the top of a release liner 110;

printing the shape of the sticker main body 120 on the top of the base film;

half-blade cutting the base film and the adhesive along the shape of the sticker main body 120 printed on the top of the base film;

removing the base film passed through the half-blade cutting from the release liner 110 and forming the sticker main body 120 on the top of the release liner 110; and

forming a guide portion 130 on the top surface of the sticker main body 120 formed on the top of the release liner 110.

First, the base film treated with an adhesive on the bottom surface thereof is disposed on the top surface of the release liner 110. Next, the shape of the sticker main body 120 is printed on the top of the base film in a form to be realized as the design layer 126 of the sticker main body 120. Then, the remaining non-printed portion of the base film and the printed portion of the base film are cut in the operation of half-blade cutting. The cutting operation is carried out not by cutting the release liner 110 but by cutting the base film and the adhesive disposed on the bottom surface of the base film. In other words, although the half-blade may penetrate through a part of the thickness of the release liner 110, it may not penetrate through the whole release liner 110. Therefore, when removing the base film after the half-blade cutting, the printed portion of the base film is still retained but the non-printed portion is removed. In this manner, the sticker main body 120 is formed.

After that, while only the sticker main body 120 is retained on the top surface of the release liner 110, the guide portion 130 is attached to the top surface of the sticker main body 120, thereby finishing the manufacture of the French nail sticker disclosed herein. Particularly, the operation of forming the guide portion 130 on the top of the sticker main body 120 may include:

applying a guide adhesive on the top of the sticker main body 120;

stacking a primer layer 134a on the top of the guide adhesive;

forming a marking layer 134b including a center line representing the center of the sticker main body 120 on the top surface of the primer layer; and

forming a protective layer 134c stacked on the top of the marking layer 134b so that the content provided by the marking layer 134b is maintained even under the application of external force.

While only the sticker main body 120 is retained on the top surface of the release liner 110, a guide adhesive is applied to the top of the sticker main body 120 to form the second adhesive. After forming the guide adhesive, the primer layer 134a is printed on the top surface thereof, wherein the primer layer 134a is printed in such a manner that it protrudes out of the free end 120x of the sticker main body 120. The primer layer 134a may be formed in the same manner as a paint primer. In other words, the primer layer 134a is formed at the site where the guide film 134 is to be formed by using a silk screen printing process, etc., and then the marking layer 134b and the protective layer 134c are stacked thereon successively, thereby forming the guide film 134. The primer layer 134a is bound with the guide adhesive intended to serve as the second adhesive layer 132 but is separated from the release liner 110. Thus, even after the completion of the manufacture of the guide film 134, the primer layer 134a is still separated from the release liner 110.

After forming the primer layer 134a, the marking layer 134b is formed to print the center line or size mark on the top of the primer layer 134a. Finally, the protective layer 134c is formed so that the marking layer 134b and the primer layer 134a are covered with the protective layer 134c. In this manner, the guide portion 130 is formed.

As can be seen from the foregoing, since the French nail sticker disclosed herein includes a sticker main body having a guide portion, it is not required to scrape out the sticker main body manually when the sticker main body is detached from the release liner. Therefore, it is possible to prevent the sticker main body from being damaged by the detachment of the sticker main body from the release liner. In addition, when applying the sticker main body to a nail, it is not necessary to hold the sticker main body with a hand. Therefore, it is possible to maintain the adhesion of the sticker main body uniformly and to prevent the sticker main body from being damaged by the adhesion of the sticker main body to a nail. Further, since the guide portion has a mark related to the center and size of the sticker main body, it is possible to select a sticker main body suitable for the size of a user's nail with ease and to attach the sticker main body to the nail with the aid of the center at once. Therefore, it is possible to prevent the shape of the sticker main body from being changed during the modification of the attachment of the sticker main body.

While the present invention has been described with respect to the specific embodiments, it will be apparent to those skilled in the art that various changes and modifications may be made without departing from the spirit and scope of the invention as defined in the following claims.

What is claimed is:

1. A French nail sticker formed into the shape of the yellow line of a nail, comprising:
a sticker main body having a convex free end and a concave hyponychium end opposite to the free end;
a release liner disposed on the bottom surface of the sticker main body and intended to be bound detachably with the sticker main body; and
a guide portion intended to be bound detachably with the top surface of the sticker main body and including a grip portion protruding toward the free end of the sticker main body.

2. The French nail sticker according to claim 1, wherein the sticker main body comprises:
a first adhesive layer capable of being attached to/detached from the release liner; and
a base layer disposed on the top of the first adhesive layer and bound firmly to the first adhesive layer.

3. The French nail sticker according to claim 2, wherein the sticker main body further comprises a design layer colored and formed with a pattern on the top of the base layer, and a top coat layer provided on the uppermost part of the sticker main body in contact with the guide portion.

4. The French nail sticker according to claim 2, wherein the base layer is made of at least one selected from polypropylene (PP), polyethylene (PE), polyvinyl chloride (PVC), polyvinylidene chloride (PVDC), ethylene vinyl acetate (EVA), polyethylene terephthalate glycol (PETG) and polyurethane (PU).

5. The French nail sticker according to claim 2, wherein the guide portion comprises a guide film and a second adhesive layer;
the guide film includes an adhesive region disposed on the top of the sticker main body, and a grip portion extending from the adhesive region and protruding out of the free end of the sticker main body; and
the second adhesive layer is adhered detachably to the top of the sticker main body on one surface thereof, and adhered and fixed to the bottom of the adhesive region on the other surface thereof.

6. The French nail sticker according to claim 5, wherein the guide film comprises:
a primer layer bound with the second adhesive layer and removed from the release liner;
a marking layer printed on the top of the primer layer and representing the center of the sticker main body; and
a protective layer stacked on the top of the marking layer.

7. The French nail sticker according to claim 6, wherein the adhesion between the second adhesive layer and the sticker main body is higher than the adhesion between the first adhesive layer and the release liner.

8. The French nail sticker according to claim 7, wherein the adhesion between the second adhesive layer and the sticker main body may be 1.5-4 times higher than the adhesion between the first adhesive layer and the release liner, as measured by a Pull-Off Test according to ASTM D4541.

9. The French nail sticker according to claim 8, wherein the top coat layer of the sticker main body comprises a UV coating agent, and the primer layer comprises an acrylate-based resin.

10. The French nail sticker according to claim 6, wherein the marking layer further comprises a size mark representing the size of the sticker main body.

11. The French nail sticker according to claim 5, wherein the adhesive region is formed with the same shape as the sticker main body.

12. A method for manufacturing the French nail sticker as defined in claim 1, comprising:
stacking an adhesive and a base film to be bound with the adhesive on the top of a release liner;
printing the shape of the sticker main body on the top of the base film;
half-blade cutting the base film and the adhesive along the shape of the sticker main body printed on the top of the base film;
removing the base film passed through the half-blade cutting from the release liner and forming the sticker main body on the top of the release liner; and
forming a guide portion on the top surface of the sticker main body formed on the top of the release liner.

13. The method according to claim 12, wherein said forming the guide portion comprises:
applying a guide adhesive on the top of the sticker main body;
stacking a primer layer on the top of the guide adhesive;
forming a marking layer including a center line representing the center of the main body on the top surface of the primer layer; and
forming a protective layer stacked on the top of the marking layer so that the content provided by the marking layer is maintained even under the application of external force,
wherein the primer layer is formed in such a manner that it protrudes out of the free end of the sticker main body.

14. The method according to claim 12, wherein the base film is made of at least one selected from PP, PE, PVC, PVDC, EVA, PETG and PU.
